(19) United States
(12) Patent Application Publication
(10) Pub. No.: US 2009/0237498 A1
(43) Pub. Date: Sep. 24, 2009

(54) SYSTEM AND METHODS FOR THE IMPROVEMENT OF IMAGES GENERATED BY FIBEROPTIC IMAGING BUNDLES

(76) Inventors: Mark D. Modell, Natick, MA (US); David W. Robertson, Framingham, MA (US); Jason Y. Sproul, Watertown, MA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/401,009

(22) Filed: Mar. 10, 2009

Related U.S. Application Data
(60) Provisional application No. 61/038,233, filed on Mar. 20, 2008.

(51) Int. Cl. H04N 7/18

(52) U.S. Cl. 348/65; 348/E07.085

(57) ABSTRACT

A method according to an embodiment of the invention includes receiving a first optical image from an endoscope having a plurality of imaging fibers. A spatial frequency is identified that is associated with the plurality of imaging fibers. A second optical image is received from the endoscope. The spatial frequency is filtered from the second optical image. A method according to another embodiment includes producing an optical image of at least a portion of a body lumen using a fiberscope. The optical image is transmitted to a video camera coupled to the fiberscope. A honeycomb pattern associated with a fiber bundle of the fiberscope is removed from the optical image. In some embodiments, the honeycomb pattern can be removed in substantially real time. In some embodiments, prior to producing the optical image, a calibration cap is coupled to the fiberscope and used in a calibration process.

### CROSS-REFERENCE TO RELATED APPLICATIONS

This application claims priority to U.S. Provisional Patent Application Ser. No. 61/038,233, entitled “System and Methods for the Improvement of Images Generated by Fiberoptic Imaging Bundles,” filed Mar. 20, 2008, the disclosure of which is incorporated herein by reference in its entirety.

### BACKGROUND

The invention relates generally to medical devices and more particularly to endoscopic imaging devices and methods for using such devices.

A variety of known types of endoscopes can be used for various medical procedures, such as procedures within a urogenital or gastrointestinal system and vascular lumens. Some known endoscopes include optical fibers for providing imaging capabilities via a remote sensor. Such endoscopes are often referred to as fiberscopes to differentiate them from video or electronic endoscopes that include a semiconductor imager within the endoscope, and the image is transmitted electronically from the endoscope to a video monitor. Some such semiconductor imagers are based on charge-coupled device (CCD) technology, and complementary metal-oxide semiconductor (CMOS) technology has also been used in the development of many types of video or electronic endoscopes. Video or electronic endoscopes, however, are typically incapable of being configured at small sizes to be used in areas of a body requiring a thin or ultra thin endoscope. For example, in areas less than 2 mm in diameter, fiberscopes often have been the only practical solution.

Images from a fiberscope can be captured by an external electronic video camera, and projected on a video display. In typical fiberoptic imaging, the resulting image can include a black honeycomb pattern. This “honeycomb” effect or pattern, as it is often referred, appears as if superimposed over an image, and is caused by the fiber cladding and the space between individual fibers within a fiber bundle where no light is collected.

A need exists for a fiberscope and system for imaging a body lumen that can remove and/or reduce the honeycomb effect in the images produced by the fiberscope and improve the resolution of the images.

### SUMMARY OF THE INVENTION

A method according to an embodiment of the invention includes receiving a first optical image from an endoscope having a plurality of imaging fibers. A spatial frequency is identified that is associated with the plurality of imaging fibers. A second optical image is received from the endoscope. The spatial frequency is filtered from the second optical image. A method according to another embodiment includes producing an optical image of at least a portion of a body lumen using a fiberscope. The optical image is transmitted to a video camera coupled to the fiberscope. A honeycomb pattern associated with a fiber bundle of the fiberscope is removed from the optical image. In some embodiments, the honeycomb pattern can be removed in substantially real time. In some embodiments, prior to producing the optical image, a calibration cap is coupled to the fiberscope and used in a calibration process.

### BRIEF DESCRIPTION OF THE DRAWINGS

FIG. 1 is a schematic illustration of an endoscope device and system according to an embodiment of the invention.

FIG. 2 is a schematic representation of a portion of an endoscope illustrating the imaging of an object according to an embodiment of the invention.

FIG. 3 illustrates an example of a honeycomb pattern from a portion of an image taken with a fiberoptic endoscope.

FIG. 4 is a schematic representation of a portion of an endoscope and system according to an embodiment of the invention.

FIG. 5 is a side perspective view of a distal end portion of an endoscope and a calibration cap according to an embodiment of the invention.

FIGS. 6-8 are each a flow chart illustrating a method of filtering an image according to an embodiment of the invention.

FIG. 9 illustrates an example of a Fourier transformed 2-dimensional spectrum of a flat-field honeycomb image.

FIG. 10 illustrates an example of a Fourier transformed 2-dimensional image.

FIG. 11 illustrates the image of FIG. 10 after a filtering process.

### DETAILED DESCRIPTION

The devices and methods described herein are generally directed to the use of an endoscope, and more specifically a fiberoptic endoscope, within a body lumen of a patient. For example, the devices and methods are suitable for use within a gastrointestinal lumen or a ureter. An endoscope system as described herein can be used to illuminate a body lumen and provide an image of the body lumen or an object within the body lumen, that has improved quality over images produced by known fiberoptic endoscopes and systems. For example, devices and methods are described herein that can reduce or remove the “honeycomb” pattern from an image before it is displayed, for example, on a video monitor. Such a “honeycomb” effect as referred to herein can result from the projection within the image of the space between fibers within a fiberoptic bundle of an endoscope.

In one embodiment, a method includes receiving a first optical image from an endoscope having a plurality of imaging fibers. A spatial frequency is identified that is associated with the plurality of imaging fibers. A second optical image is received from the endoscope. The spatial frequency is filtered from the second optical image.

In another embodiment, a method includes producing an optical image of at least a portion of a body lumen using a fiberscope. The optical image is transmitted to a video camera coupled to the fiberscope. A honeycomb pattern associated with a fiber bundle of the fiberscope is removed from the optical image. In some embodiments, the honeycomb pattern can be removed in substantially real time. In some embodiments, prior to producing the optical image, a calibration cap is coupled to the fiberscope and used in a calibration process.

In another embodiment, a processor-readable medium stores code representing instructions to cause a processor to receive a signal associated with a first optical image from a fiberscope having multiple imaging fibers. The code can cause the processor to identify a pixel position associated with each fiber from the plurality of fibers. The code can cause the processor to receive a signal associated with a second optical image from the fiberscope, and filter the pixel position associated with each fiber from the plurality of fibers from the second optical image.

It is noted that, as used in this written description and the appended claims, the singular forms “a,” “an” and “the” include plural referents unless the context clearly dictates otherwise. Thus, for example, the term “a fiber” is intended to mean a single fiber or a collection of fibers. Furthermore, the words “proximal” and “distal” refer to direction closer to and away from, respectively, an operator (e.g., surgeon, physician, nurse, technician, etc.) who would insert the medical device into the patient, with the tip-end (i.e., distal end) of the device inserted inside a patient's body. Thus, for example, the endoscope end inserted inside a patient's body would be the distal end of the endoscope, while the endoscope end outside a patient's body would be the proximal end of the endoscope.

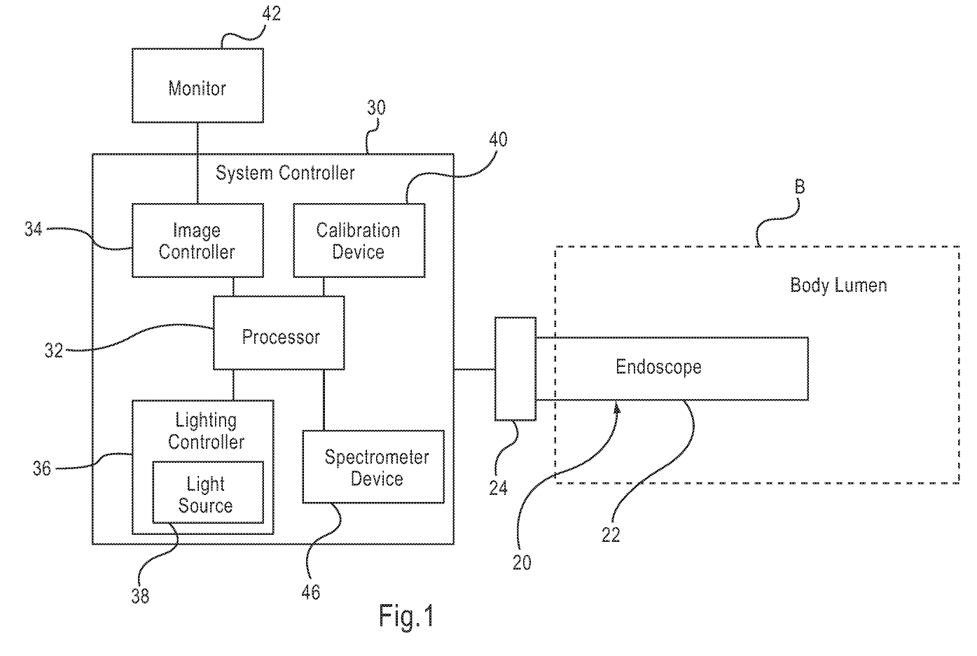

FIG. 1 is a schematic representation of an endoscope system according to an embodiment of the invention. An endoscope 20 includes an elongate portion 22 that can be inserted at least partially into a body lumen B, and a handle portion 24 outside the body lumen B. The endoscope 20 can optionally include one or more lumens extending through the elongate portion and/or handle portion. The elongate portion can be flexible, or can include a portion that is flexible, to allow the elongate portion to be maneuvered within a body lumen. The endoscope 20 can be inserted into a variety of different body lumens or cavities, such as, for example, a ureter, a gastrointestinal lumen, an esophagus, a vascular lumen, etc. The handle portion 24 can include one or more control mechanisms that can be used to control and maneuver the elongate portion of the endoscope 20 through the body lumen.

As stated above, the endoscope 20 can define one or more lumens. In some embodiments, the endoscope 20 includes a single lumen through which various components can be received. For example, optical fibers or electrical wires (not shown in FIG. 1) can pass through a lumen of the endoscope 20 to provide illumination and/or imaging capabilities at a distal end portion of the endoscope 20. For example, the endoscope 20 can include imaging fibers and/or illumination fibers (not shown in FIG. 1). The endoscope 20 can also be configured to receive various medical devices or tools (not shown in FIG. 1) through one or more lumens of the endoscope (not shown in FIG. 1), such as, for example, irrigation and/or suction devices, forceps, drills, snares, needles, etc. An example of such an endoscope with multiple lumens is described in U.S. Pat. No. 6,296,608 to Daniels et, al., the disclosure of which is incorporated herein by reference in its entirety. In some embodiments, a fluid channel (not shown in FIG. 1) is defined by the endoscope 20 and coupled at a proximal end to a fluid source (not shown in FIG. 1). The fluid channel can be used to irrigate an interior of a body lumen. In some embodiments, an eyepiece (not shown in FIG. 1) can be coupled to a proximal end portion of the endoscope 20, for example, adjacent the handle 24, and coupled to an optical fiber that can be disposed within a lumen of the endoscope 20. Such an embodiment allows a physician to view the interior of a body lumen through the eyepiece.

A system controller 30 can be coupled to the endoscope 20 and configured to control various elements of the endoscope 20 as described in more detail below. The system controller 30 can include a processor 32, an imaging controller 34, a lighting controller 36, a calibration device 40 and/or a spectrometer 46. In alternative embodiments, each of these devices can be provided as separate components separate from the system controller 30. The light source 38 can be configured to provide light at various different wavelengths. The imaging controller 34 includes an imaging device (not shown in FIG. 1) and a processor (not shown in FIG. 1), and can be coupled to a video monitor 42. The endoscope 20 can also optionally include optical fibers (not shown in FIG. 1) configured to transmit light back to the spectrometer device 46 for a spectral analysis of the interior of the body lumen.

The endoscope 20 can also include one or more illumination fibers (not shown in FIG. 1) that can be coupled to the lighting controller 36. The illumination fibers can be used to transfer light from a light source 38, through the endoscope 20, and into the body lumen B. Illumination fibers can also be used to transfer light to the spectrometer 46. The illumination fibers can be formed, for example, from a quartz glass component or other suitable glass or polymer material capable of transmitting and receiving various wavelengths of light. The illumination fibers can be a single fiber or a bundle of multiple fibers. The light source can be configured to emit light at a variety of different wavelengths. For example, the light source 38 can emit light at various wavelengths associated with visible light, infrared light and/or ultraviolet light.

The endoscope 20 can also include imaging fibers (not shown in FIG. 1) that can be disposed through a lumen (not shown in FIG. 1) of the endoscope 20 and coupled to the imaging controller 34. The imaging fibers can be disposed through the same or different lumen of the endoscope 20 as the illumination fibers. Images of a body lumen and/or an object within the body lumen can be captured and processed by the imaging controller 34. The captured and processed images can also be displayed on the video monitor 42.

The endoscope 20 can also include a calibration device 40 and a removable calibration cap (not shown). The calibration cap can be removably coupled to a distal end of the imaging fibers, and a proximal end of the imaging fibers can be coupled to the calibration device 40. The calibration device 40 can be used in conjunction with the calibration cap during calibration of the endoscope and in conjunction with the image controller 34 to reduce or remove the honeycomb effect of an image as described in more detail below.

The processor 32 of the systems controller 30 can be operatively coupled to the lighting controller 36 and the image controller 34. The processor 32 (e.g., central processing unit (CPU)) includes a memory component, and can store and process images or other data received from or in connection with the endoscope 20. The processor 32 can analyze images, and calculate and analyze various parameters and/or characteristics associated with an image or other data provided by or in connection with the endoscope 20. The processor 32 can be operatively coupled to the various components of the system controller 30. As stated above, in alternative embodiments, the lighting controller 36, the imaging controller 34 and/or spectrometer device 46 are separate devices and can be coupled to the endoscope 20 using a separate connector or connectors. In such an embodiment, the imaging controller 34, lighting controller 36, and spectrometer device 46 can optionally be coupled to each other and/or a system controller 30. The processor 32 can also be operatively coupled to the calibration device 40.

The processor 32 includes a processor-readable medium for storing code representing instructions to cause the processor 32 to perform a process. Such code can be, for example, source code or object code. The code can cause the processor 32 to perform various techniques for filtering images taken with a fiberscope. For example, the code can cause the processor 32 to reduce and/or remove a honeycomb pattern associated with the imaging fibers and/or dark spots from an image. The processor 32 can be in communication with other processors, for example, within a network, such as an intranet, such as a local or wide area network, or an extranet, such as the World Wide Web or the Internet. The network can be physically implemented on a wireless or wired network, on leased or dedicated lines, including a virtual private network (VPN).

The processor 32 can be, for example, a commercially-available personal computer, or a less complex computing or processing device that is dedicated to performing one or more specific tasks. For example, the processor 32 can be a terminal dedicated to providing an interactive graphical user interface (GUI). The processor 32, according to one or more embodiments of the invention, can be a commercially-available microprocessor. Alternatively, the processor 32 can be an application-specific integrated circuit (ASIC) or a combination of ASICs, which are designed to achieve one or more specific functions, or enable one or more specific devices or applications. In yet another embodiment, the processor 32 can be an analog or digital circuit, or a combination of multiple circuits.

The processor 32 can include a memory component. The memory component can include one or more types of memory. For example, the memory component can include a read only memory (ROM) component and a random access memory (RAM) component. The memory component can also include other types of memory that are suitable for storing data in a form retrievable by the processor. For example, electronically programmable read only memory (EPROM), erasable electronically programmable read only memory (EEPROM), flash memory, as well as other suitable forms of memory can be included within the memory component. The processor 32 can also include a variety of other components, such as for example, co-processors, graphic processors, etc., depending, for example, upon the desired functionality of the code.

The processor 32 can store data in the memory component or retrieve data previously stored in the memory component. The components of the processor 32 can communicate with devices external to the processor 32, for example, by way of an input/output (I/O) component (not shown). According to one or more embodiments of the invention, the I/O component can include a variety of suitable communication interfaces. For example, the I/O component can include, for example, wired connections, such as standard serial ports, parallel ports, universal serial bus (USB) ports, S-video ports, local area network (LAN) ports, small computer system interface (SCCI) ports, and so forth. Additionally, the I/O component can include, for example, wireless connections, such as infrared ports, optical ports, Bluetooth® wireless ports, wireless LAN ports, or the like.

As discussed above, the endoscope 20 can be used to illuminate and image a body lumen B, and can also be used to identify an area of interest within the body lumen B. The endoscope 20 can be inserted at least partially into a body lumen B, such as a ureter, and the lighting controller 36 and illumination fibers collectively can be used to illuminate the body lumen or a portion of the body lumen. The body lumen can be observed while being illuminated via an eyepiece as described above, or the body lumen can be imaged using the imaging controller 34 and video monitor 42. In embodiments where the endoscope 20 is coupled to a spectrometer 46, the light intensity can also be measured. For example, the portion of the image associated with the area of interest can be measured by the spectrometer 46.

Endoscopes as described herein that use optical fibers to transmit an image from a distal end to a proximal end of the endoscope are often referred to as fiberscopes. Fiberscopes can be configured to be used in areas within a body that require a thin or ultra thin endoscopes, for example, in areas less than 2 mm in diameter. In addition, a fiberscope can be configured with a relatively long length because the light losses in most fibers made, for example, of glass cores and cladding, are tolerable over distances of up to several meters.

Many fiberscopes use similar optical structures and can vary, for example, in length, total diameter, maneuverability and accessories, such as forceps, etc. The diameter of an individual glass fiber in an image conveying bundle of fibers can be made very small and can be limited in some cases, by the wavelength of the light being transmitted. For example, a diameter of an individual fiber can be in the range of 2 to 15 micrometers. Thus, a fiberscope can include a variety of different features, and be a variety of different sizes depending on the particular application for which it is needed.

Although a single optical fiber cannot usually transmit images, a flexible bundle of thin optical fibers can be constructed in a manner that does allow for the transmission of images. If the individual fibers in the bundle are aligned with respect to each other, each optical fiber can transmit the intensity and color of one object portion or point-like area. This type of fiber bundle is usually referred to as a “coherent” or “aligned” bundle. The resulting array of aligned fibers can then convey a halftone image of the viewed object, which is in contact with the entrance face of the fiber array. To obtain the image of objects that are at a distance from the imaging bundle, or imaging guide, it may be desirable to use a distal lens that images the distal object onto the entrance face of the aligned fiberoptic bundle. The halftone screen-like image formed on the proximal or exit face of a bundle of aligned fibers can be viewed through an eye lens or on a video monitor if the exit face is projected by lens onto a video sensor or detector.

The aligned fiber bundle produces an image in a mosaic pattern (often organized as a honeycomb), which represents the boundaries of the individual fibers and which appears superimposed on the viewed image. Hence, the viewer sees the image as if through a screen or mesh. Any broken fiber in the imaging bundle can appear as a dark spot within the image.

A physician or user can view the endoscopic images on a video monitor. The proximal end of the imaging fiber bundle is re-imaged with one or more lenses onto a video sensor or detector (e.g., a CCD based video camera). On the video monitor, the physician can view the images of the targeted tissue or organ where the images appear to have the honeycomb pattern and dark spots superimposed on the images. Such dark spots and honeycomb pattern can be distracting and decrease the efficiency of the observation by the physician/user, and the diagnostic decisions based on those observations. In some cases, a physician can de-focus the video camera lens slightly so that the proximal face of the imaging bundle does not have as high contrast image of the pattern or dark spots. Such a process, however, can defocus the features of the tissue or organ being examined can be diminished within the image. Thus, the physician or user's ability to observe and make a decision based on the observation of an image having a honeycomb pattern and/or one or more dark spots can be diminished.

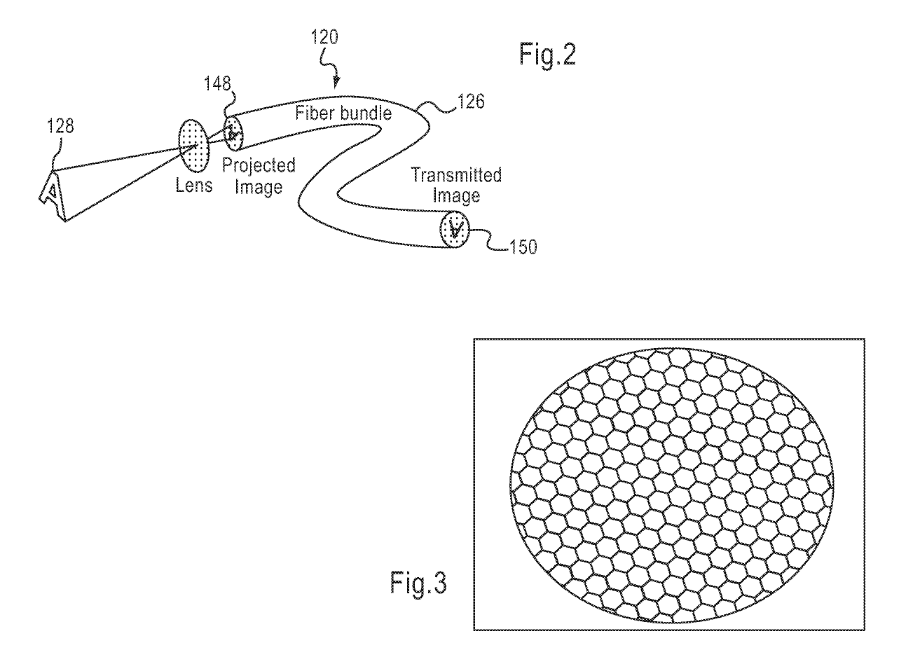

FIGS. 2 and 3 illustrate the use of a known fiberoptic imaging device. Fiberoptic image bundles used in endoscopes can contain, for example, coherent bundles of 2,000 to more than 100,000 individual optical fibers. For example, typical fiber bundles used in urological and gynecological endoscopes have 3,000 to 6,000 optical fibers. A portion of an endoscope 120 including a fiberoptic bundle 126 (also referred to herein as “fibers” or “optical fibers”) is shown schematically in FIG. 2. FIG. 2 illustrates the imaging of an object 128 using the fiberoptic bundle 126. An image is transmitted by focusing light from the object 128 onto a projection end 148 of the fibers 126 via a lens, and viewing the pattern of light exiting the fiberoptic bundle 126 at a receiver end 150 of the endoscope 120. The transmitted image corresponds to the projected image because the fibers 126 are maintained in the same order at both ends (projection end 148 and receiver end 150) of the fiberoptic bundle 126.

The light transmission fibers, such as fibers 126, are typically round, and are packed together to form a close or tight fit bundle of fibers. Even with this close packing of the fibers, space typically exists between individual fibers where no light is transmitted, which can result in a black honeycomb pattern that appears superimposed over the image, such as is illustrated in FIG. 3. Images from the fiberoptic bundle 126 can be captured by an electronic video camera, and after processing, can be projected on a video display. Devices and methods are described herein to reduce or remove the honeycomb pattern from an image before it is displayed on a video monitor. As described in more detail below, the removal of the honeycomb effect can be accomplished by recording the location of the detector pixels corresponding to the honeycomb pattern during calibration of a high-pixel-count detector or sensor (e.g., within a digital video camera), and by subtracting or deleting the honeycomb pattern from the image to be displayed in substantially real time. These pixels are replaced by any of several known methods of pixel interpolation or averaging used in digital image processing. The removal of the honeycomb pattern provides a resulting image that can be less distracting and have a higher resolution.

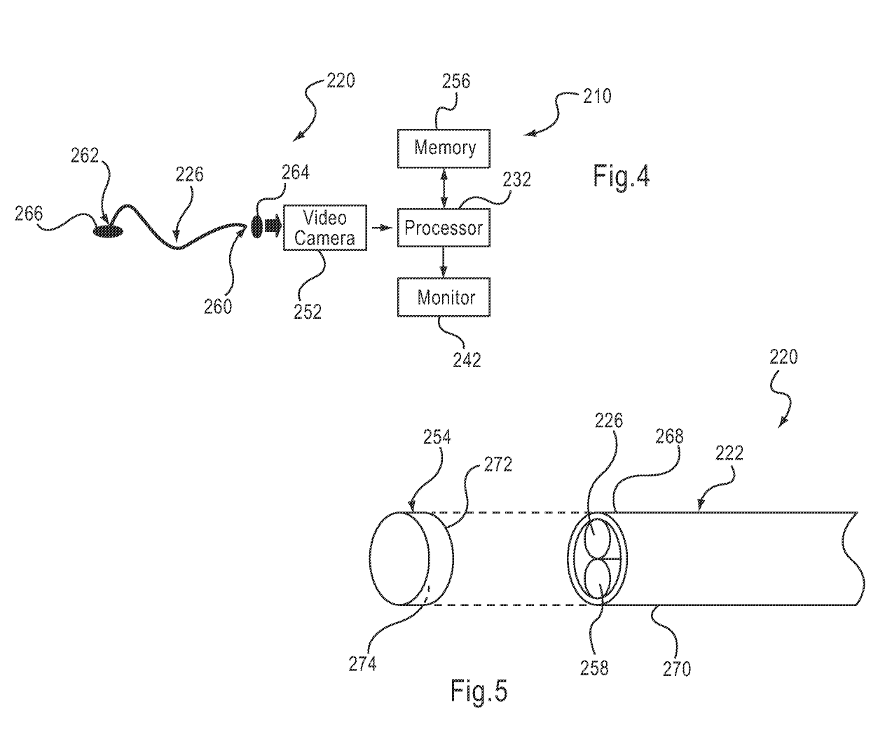

FIGS. 4 and 5 illustrate an endoscope system 210 according to an embodiment of the invention. FIG. 4 is a schematic representation of the endoscope system 210, and FIG. 5 is a side perspective view of a distal end portion of an endoscope 220. The endoscope system 210 includes the endoscope 220, a video camera 252, a processor 232 and a video monitor 242. The endoscope 220 includes a flexible elongate portion 222 (shown in FIG. 5 only) that includes a fiber bundle 226 that can be used for imaging, and one or more illumination fibers 258 (shown in FIG. 5 only) that can be used to illuminate the body lumen within which the endoscope 220 is disposed. FIG. 4 illustrates only the fiber bundle 226 of the endoscope 220. The elongate portion 222 can include a sheath or covering 270 having one or more lumens to house the fiber bundle 226 and illumination fibers 258, as shown in FIG. 5. In some embodiments, the elongate portion 222 does not include a sheath 270.

A proximal end face 260 of the fiber bundle 226 is coupled to a lens 264 and a video camera 252. A proximal end portion of the illumination fibers 258 is coupled to a light source (not sown in FIG. 4). The video camera 252 is coupled to the processor 232, which is coupled to the video monitor 242. The processor 232 also includes a memory component 256. The processor 232 can be configured to process images in real time (or in substantially real time) during imaging of a body lumen and/or object (e.g., tissue or organ) within a body lumen. A distal lens 266 can also optionally be coupled at or adjacent to a distal end face 262 of the fiber bundle 226. As stated above, the distal lens 266 can be used to image or focus objects that are located at a distance from the distal end face 262 of the fiber bundle 226.

In this embodiment, a process of improving image quality by reducing or eliminating the honeycomb pattern and/or dark spots from an image, first includes a calibration process prior to imaging a body lumen or an object within a body lumen. The calibration process includes calibrating a sensor or detector of the video camera 252 using a “white balance” calibration process to provide a reproduction of color to coordinate with the illumination source used. First, the light source and illumination fibers 258 are activated to provide illumination. The endoscope 220 is then pointed at a substantially white surface and a white balance actuator (not shown) on the controller (not shown) of the video camera 252 is actuated. The processor 232 is configured with a software imaging-processing algorithm that can automatically adjust the color of the image.

To ensure that the initial calibration provides a substantially completely white image to allow separation of the location of the fibers and the honeycomb pattern within an image, a calibration cap 254 can be used. The calibration cap 254 is removably couplable to a distal end 268 of the elongate body 222. FIG. 5 illustrates the calibration cap 254 removed from the elongate portion 222 for illustration purposes. To calibrate the detector of the camera 252, the calibration cap 254 is placed on the distal end 268 of the elongate body 222. The calibration cap 254 defines an opening 272 that can be sized to fit over the distal end 268 of the elongate body 222. The calibration cap 254 has a white or diffusing interior surface within an interior region 274. The interior surface reflects a constant color and brightness to each of the imaging fibers within the imaging fiber bundle 226 when the interior region 274 is illuminated by the illumination fibers 258 allowing capture and storage of an image of the honeycomb pattern and dark spots. After actuating the white balance actuator on the video camera 252, the calibration cap 254 is removed from the distal end 268 of the elongate portion 222.

After being calibrated, the endoscope 220 can be used to illuminate and image a portion of a body lumen, such as, for example, a ureter. The flexible elongate portion 222 of the endoscope 220 can be maneuvered through the body lumen using controls (not shown) on a handle (not shown) of the endoscope 220. Once the endoscope 220 is positioned at a desired location within the body lumen, the body lumen can be illuminated with the illumination fibers 258. The body lumen can then be imaged using the imaging fiber bundle 226. During imaging, when the proximal end face 260 of the imaging fiber bundle 226 is re-imaged onto the detector of the video camera 242 via lens 260, the video monitor 242 that is coupled to the camera 242 can display the image of the proximal end face 260. This image can include the examined tissue or organ along with a honeycomb pattern and/or dark spots included within the image.

The optical image is transmitted from the fiber bundle 226 to the processor 232 in substantially real time. The processor 232 can then remove the honeycomb pattern and/or dark spots or any other permanent structure in the proximal end face 260 of the imaging fiber bundle 226 using one of the processes described in more detail below. The resulting video image, having distractions such as a honeycomb pattern and/or dark spot removed can then be transmitted to the monitor 242 to be displayed. The image can also be stored in the memory 256 or printed via a printer (not shown) that can be optionally coupled to the processor 232.

The images of the fiber bundle 226 captured during the calibration process can be used to identify the honeycomb pattern in an image. The honeycomb pattern and a sensor pattern of the video camera 242 can be stationary relative to each other. In other words, the images of the fiber bundle 226 captured during the calibration process can be used to identify the rotational position of the honeycomb within the image captured by the video camera 242. A feature (described in more detail below) can be identified within the image and can be used during an image-correcting process to remove the honeycomb pattern (and other blemishes visible on the distal end face 262 and proximal end face 260 of the imaging fiber bundle 226) from the images displayed on the monitor 252. To do this, the image is captured when the distal end face 262 is observing a uniformly illuminated unstructured target (e.g., the calibration cap 254). The image is processed to identify the desired features of the image at the proximal end face 260 and the features are stored in the memory 256 coupled to the processor 232.

The feature or features of the honeycomb pattern can be based on, for example, fiber positions, fiber dimensions and/or shape, fiber shape boundaries, intensity distribution within the boundaries, spatial frequencies of the image, contrast of the honeycomb image, etc. The feature(s) used to filter the honeycomb pattern can be selected, for example, by the image-correction processing method for removal of the proximal end face 260 fiber pattern. The processing can be implemented, for example, in a space domain or a frequency domain, or in a combination of both.

As mentioned above, the honeycomb pattern can be removed from an image by first recording the location of the pixels of the honeycomb pattern during calibration (as described above) of a high-pixel-count digital video camera, and then subtracting or deleting the pattern from the image to be displayed in substantially real time, as described in more detail below. The removed pixels can be replaced by any of several known methods of pixel interpolation or averaging used in digital image processing.

One example method to remove the pixels of the honeycomb pattern includes using a space-domain processing technique. With this technique, the positions within an image corresponding to individual fibers within the fiber bundle 226, and the associated pixels of the detector of the video camera 252 are identified. For example, as described above, an image produced via the fiber bundle 226 can be captured during calibration. The image portion corresponding to each fiber can be represented by a position of its centerline and a boundary of a perimeter of each fiber expressed in the pixel positions in, for example, a charge couple device (CCD) sensor of the video camera 242. The pixels within the boundary for each fiber within the fiber bundle 226 typically have the same intensity (e.g., the number of photons) because each fiber collects optical energy as a single point on the quantified image of the plane in which the proximal end face 260 of the fiber bundle 226 lies. In other words, the sensor pixels associated with a given fiber will typically have the same intensity levels because each fiber will uniformly collect a given amount of light over the field of view for that fiber. The processor 232 can store this information regarding the pattern of the proximal end face 260 in the memory 256.

Because the center pixel of each fiber within the boundary of each fiber are identified, the processor 232 can measure in substantially real time the intensity of the central pixel and set the intensity of the other pixels within the boundary to the same level as the center pixel. Thus, the honeycomb pattern (i.e., a boundary pattern) of the fiber bundle 226 will not be visible in the image of the tissue or organ that is displayed on the monitor 242, and thus appear removed or deleted. In some cases, it may be desirable to use more than one pixel (e.g., more than the central pixel) to represent the fiber. The selection of how many pixels to use can be based, for example, on the number of pixels within the fiber image. For example, the higher resolution of the video camera (e.g., depends on the type of video lens, and pixels within the video sensor), the higher the number of pixels that can be used.

In another example method, a frequency-domain processing technique is used to reduce or remove the honeycomb pattern. In this technique, the processor 232 can calculate a Fourier transform of the honeycomb pattern (e.g., as shown in FIG. 3) and determine the spatial frequencies of the fiber dimensions and fiber image boundaries from the image captured during calibration. The frequency corresponding to the fiber dimension can be the highest spatial frequency of the quantified image at the proximal end face 260. Thus, any higher spatial frequency in the image at the proximal end face 260 is an artifact caused by, for example, the higher resolution of the video lens 264 and sensor (not shown) of the video camera 252. The processor 232 can identify the spatial frequencies associated with the fiber dimension and store it in the memory 256. The spatial frequency that corresponds to the fiber dimension identifies the useful bandwidth of the fiberscope (e.g., endoscope 220) imaging capabilities. Such a bandwidth can be a range of spatial frequencies between a zero spatial frequency and the highest spatial frequency associated with the fibers. When imaging begins, the processor 232 transforms the images of the tissue or organ in substantially real time, removing the spatial frequencies greater than the spatial frequency associated with the fiber dimension and passing frequencies within the bandwidth (i.e., performing a low-pass filtering of the images or bandpass filtering of the images from zero spatial frequency to the upper limit). The processor 232 then performs an inverse Fourier transform. The honeycomb pattern will not be visible in the resulting images that are displayed on the monitor 242.

As described above, the processor 232 can be configured to operate the honeycomb subtraction process continuously during imaging (e.g., in substantially real time). To accomplish this continuous operation, the orientation between the fiber imaging bundle 226 and the digital video camera 252 is first identified. This can be done by fixing the orientation permanently, or by fixing a physical reference mark such as a notch or colored tag (not shown) to the imaging bundle 226. The software within the processor 232 can record the location of such a mark during calibration, and then use it to orient the honeycomb subtraction pattern to each video frame. This method can also be used to mask or reduce the black spots on a fiberoptic image caused by broken imaging fibers, for example, within the fiber bundle 226.

The various components of an endoscope described herein can be formed with a variety of different biocompatible plastics and/or metals. For example, the elongate body of the endoscope can be formed with one or more materials such as, titanium, stainless steel, or various polymers. The optical fibers (e.g., imaging fibers and illumination fibers) can be formed with various glass or plastic materials suitable for such uses. The optical fibers can also include a cladding formed with a polymer or other plastic material.

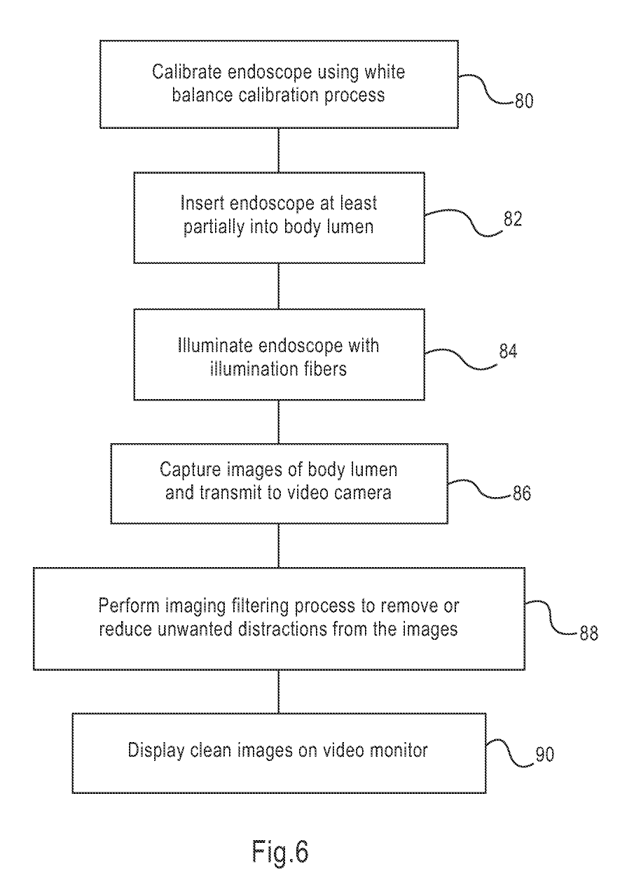

FIG. 6 is a flow chart illustrating a method of using an endoscope system according to an embodiment of the invention. At 80, an endoscope is calibrated using a white-balance calibration process as described herein. The calibration process can include, for example, placing a cap on a distal end of the endoscope as described above. At 82, the endoscope is inserted at least partially into a body lumen or cavity. The body lumen can be for example, a ureter, a gastrointestinal lumen, or other body cavity. The endoscope can include an imaging fiber bundle and one or more illumination fibers as described herein. At 84, the endoscope is illuminated using the illumination fibers. At 86, images of the body lumen can be captured and transmitted to a video camera coupled to the endoscope. At 88, a processor coupled to the video camera can perform an imaging-filtering process to remove or reduce unwanted distractions from the images. For example, a honeycomb pattern and/or unwanted dark spots that would otherwise be visible in the images can be removed or reduced from the images. At 90, the resulting “clean” images can be displayed on a video monitor coupled to the processor.

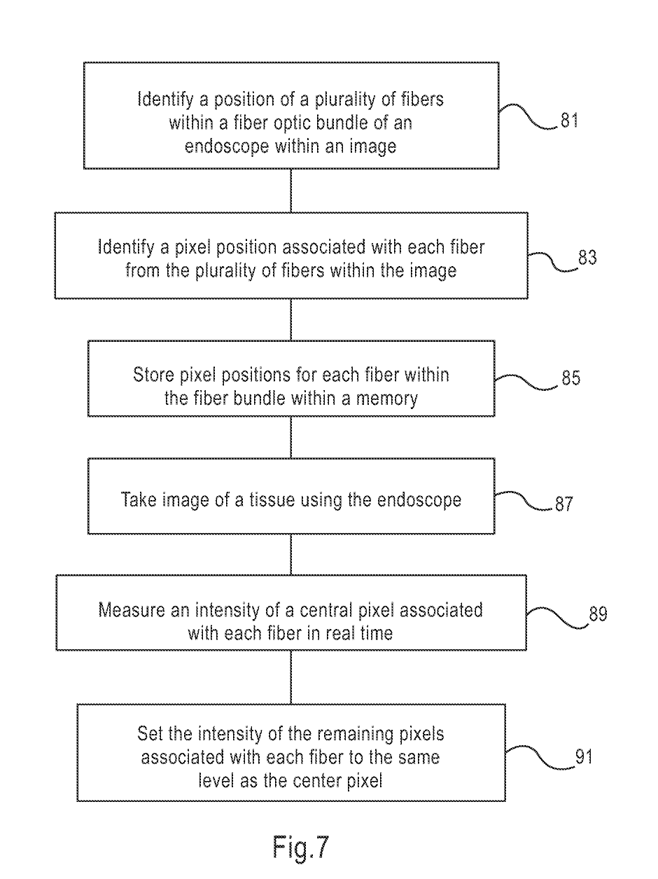

FIG. 7 is a flow chart illustrating a method of filtering an image generated by an endoscope according to an embodiment of the invention. At 81, a position of a plurality of fibers within a fiber optic bundle are identified within an image. At 83, a pixel position associated with each fiber from the plurality of fibers within the image is identified. At 85, the pixel positions for each fiber within the fiber bundle is stored within a memory. At 87, an image is taken of a tissue using the endoscope. At 89, an intensity of a central pixel associated with each fiber is measured in substantially real time, and at 91, the intensity of the remaining pixels associated with each fiber is set to the same level as the center pixel associated with that fiber.

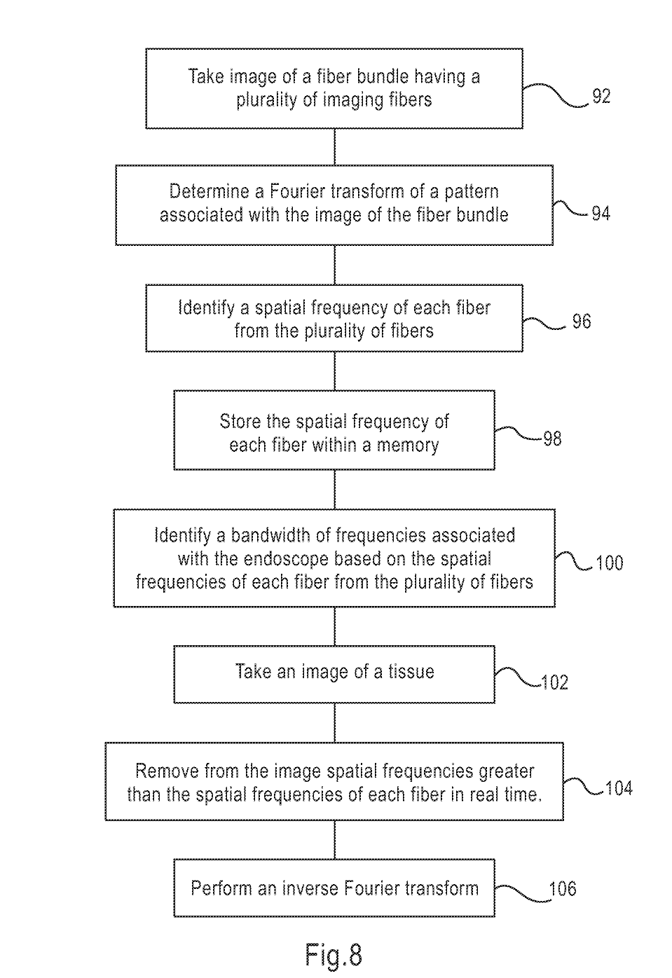

FIG. 8 is a flow chart of another method of filtering an image generated by an endoscope according to an embodiment of the invention. At 92, an image is taken of a fiber bundle having a set of imaging fibers. At 94, a Fourier transform of a pattern associated with the image of the set of imaging fibers is determined. At 96, a spatial frequency of each fiber from the set of fibers is identified. At 98, the spatial frequency of each fiber is stored within a memory. At 100, a bandwidth of frequencies associated with the endoscope is identified based on the spatial frequencies of each fiber from the plurality of fibers. At 102, an image of a tissue is taken and at 104, spatial frequencies greater than the spatial frequencies of each fiber is removed from the image of the tissue in real time. A 106, an inverse Fourier transform is performed. The image is then displayed by a video monitor.

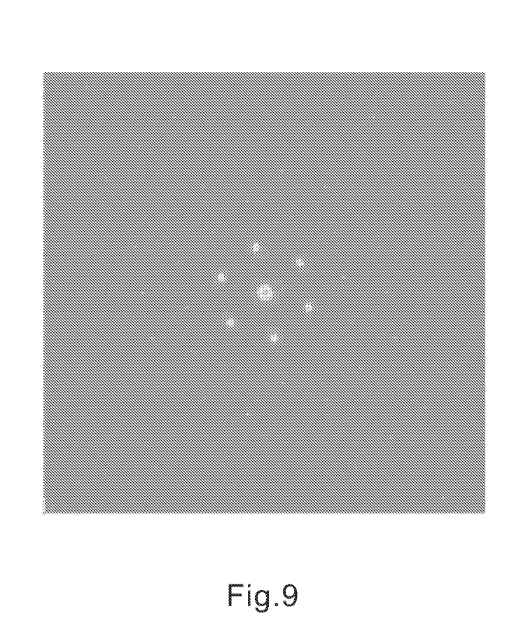

FIGS. 9-11 illustrate examples of images formed by an optical implementation of image filtering using a Fourier transform, according to an embodiment of the invention. As described above, a honeycomb pattern in an image caused by hexagonal packing of the fibers in a fiberscope can be removed by directly transforming the image data from each frame into the complex Fourier domain (frequency and phase), multiplying the transformed image by the desired filter response, and then transforming the filtered image back to the spatial domain. Alternatively, standard techniques of automated filter design can be used to create a finite impulse response (FIR) convolution kernel that is approximately the inverse Fourier transform of the desired filter response.

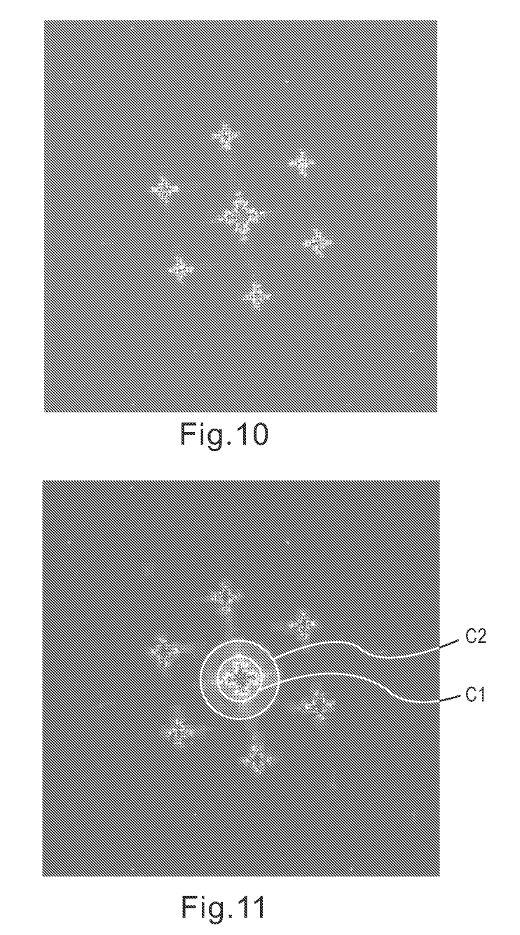

As shown in FIGS. 9-11, each of which is a Fourier transformed image, the artifacts that are produced due to a hexagonal packing of the fibers in a fiberscope are separable from a central peak, which represents the actual intended content of the image. FIG. 9 is a 2-dimensional (2D) auto-powered spectrum of a flat field honeycomb image, and FIG. 10 illustrates an image that is a Fourier transform of the image shown in FIG. 9. As previously described, by using a filter response that is symmetric about a DC (e.g., zero-frequency) axis, the frequencies corresponding to the artifacts can be suppressed, as shown in FIG. 11.

As shown in FIG. 11, the low frequencies corresponding to the bright central region of the image associated with a given fiber are retained, while the frequencies associated with the artifacts in the dimmer areas are suppressed. Two dim areas are shown, as indicated by the circles C1 and C2. The circles represent two possible filter responses where a stopband frequency is located at the edge of each circle. The smaller circle C1 represents a more aggressive filter that removes more artifacts, but can possibly suppress a small amount of the detail of the image content. The larger circle C2 represents a less aggressive filter that can leave some residual honeycomb artifacts in the image, but is less likely to suppress the actual image detail. In some embodiments, the filtering process can use an elliptical stopband frequency rather than a circular one. For example, if the vertical and horizontal spatial sampling rates within a single field have a ratio of 1:2, then the stopband frequency will have the same height-to-width ratio.

An example method that can be used to determine a nominal stopband frequency includes performing a standard threshold and region-growing operation on the 2D auto-powered spectrum of the image luma (e.g., brightness) to detect six secondary peaks (as shown in FIGS. 10 and 11). A centroid of each secondary peak is then identified. The stopband frequency is determined as one-half of an average radial distance from the DC axis to the peaks. A control mechanism, such as a dial or button used in conjunction with a monitor, can be used to enable adjustment of the stopband frequency over a particular range about a nominal value. Using a stopband frequency that is symmetric about the DC axis can prevent the filter from having to be recalculated if the fiberscope and video camera (e.g., as shown in FIG. 4) are rotated with respect to one another.

In some cases, a filter can be produced by converting from a multiplication in the Fourier domain to a finite image convolution using methods such as windowing and frequency-space sampling. The frequency response of the resulting filter will not exactly match the filter constructed in the Fourier domain, but can be sufficiently accurate to produce an image with the honeycomb pattern reduced or substantially removed. In color images, each of the primary color planes (e.g., red, green and blue) can be convolved separately.

Because the filtering process can remove some energy from the image, the image is renormalized to ensure that the filtered image has the same brightness level as the unfiltered image. This process can be dynamic because different cameras and fiberscopes can be used interchangeably, which can affect the amount of gain required to renormalize the filtered image. A feedback loop can be implemented to adjust the normalization coefficient based on a ratio of a target mean brightness of the filtered image to an actual mean value of the filtered image. Alternatively, a ratio of the mean brightness of the filtered image to a mean brightness of the unfiltered image can be used.

In some systems, when, for example, the type of fiberscope, video camera, and processor are known, or otherwise calibrated together as a system in advance of imaging, the normalization coefficient can be determined by measuring the response of the system to a uniform Lambertian surface, such as a back-illuminated diffuser. In such a case, the illumination can be adjusted such that no pixels in the image are saturated to white, which minimizes the occurrence of the filtered values being clipped. After processing the image with the appropriate stopband frequency (or frequencies) as described above, the normalization coefficient can be computed by dividing a target mean brightness of the filtered image by an actual mean brightness of the filtered image.

The filtering processes described above can add latency to the video signal, delaying its transmission from the camera to the display. To accommodate for this, a video camera can be used that has a relatively high frame rate, such as, for example, 60 fps (versus a typical 30 fps). In some embodiments, a progressive-scan camera can be used to simplify the calculation of the filter coefficient. If the input signal is an interlaced signal, rather than a progressive scan, a scan-converter can be incorporated. In such an embodiment, the scan-converter can interpolate the time-sequential fields of the video stream into a progressive-scan signal by creating an output frame rate that is the same as the input field rate (e.g., 59.94 Hz for NTSC format signals, 50 Hz for PAL format signals). If the output signal needs to be interlaced, such as, for example, with a S-Video system, and the internal processing of the filter is performed with a progressive scan signal, a scan-converter can be incorporated to generate an interlaced output signal. Such a process can be simplified if the input progressive scan frame rate is the same as the output interlaced field rate.

In sum, a processor according to an embodiment of the invention can receive multiple signals associated with an optical image from a fiberscope. A Fourier transform on the optical image can then be performed based on these signals and multiple signals can be produced that are associated with the transformed image. The transformed image can be filtered based on those signals and based on a selected stopband frequency as described above. For example, the filtering process can suppress within the image frequencies that are greater than the stopband frequency, while allowing frequencies that are less than the stopband frequency to remain within the optical image. Thus, the frequencies that are associated with unwanted artifacts (e.g., produced by the fibers of the fiberscope) in the optical image are removed. The image can then be normalized based on the signals produced by the filtered image as described above.

Some embodiments relate to a computer storage product with a computer-readable medium (also can be referred to as a processor-readable medium) having instructions or computer code thereon for performing various computer-implemented operations. The media and computer code (also can be referred to as code) may be those specially designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signals; and hardware devices that are specially configured to store and execute program code, such as Application-Specific Integrated Circuits (ASICs), Programmable Logic Devices (PLDs), and ROM and RAM devices. Examples of computer code include, but are not limited to, micro-code or micro-instructions, machine instructions, such as produced by a compiler, and files containing higher-level instructions that are executed by a computer using an interpreter. For example, an embodiment of the invention can be implemented using Java, C++, or other object-oriented programming language and development tools. Additional examples of computer code include, but are not limited to, control signals, encrypted code, and compressed code.

Although some embodiments herein are described in connection with optical images and the processes performed in connection with these optical images, it should be understood that all such embodiments can be considered in connection with signals (e.g., analog or digital signals) that are associated with or represent these optical images and the related processes. Similarly, to the extent that some embodiments here are described in connection with such signals, it should be understood that all such embodiments can be considered in connection with the associated optical images and the processes with respect to these optical images.

In one embodiment, a method includes receiving a first optical image from an endoscope having a plurality of imaging fibers and identifying a spatial frequency associated with the plurality of imaging fibers. A second optical image is received from the endoscope and the spatial frequency is filtered from the second optical image. The method can further include storing the spatial frequency associated with the plurality of imaging fibers within a memory. In some embodiments, identifying a spatial frequency can include performing a Fourier transform to an image having a honeycomb pattern associated with the plurality of fibers. In some embodiments, filtering the spatial frequency from the second optical image can be done substantially in real time. In some embodiments, the method can further include displaying the second optical image on a video monitor after the filtering. In some embodiments, the method can further include identifying a mark coupled to at least one fiber from the plurality of fibers within the first image; and recording a location of the mark in the memory. In some embodiments, the method can further include determining a bandwidth of frequencies associated with the endoscope based on the spatial frequency associated with the plurality of fibers before filtering the spatial frequency from the second optical image. In some embodiments, the method can further include determining a bandwidth of frequencies associated with the endoscope based on the spatial frequency associated with the plurality of fibers before filtering the spatial frequency from the second optical image. In such an embodiment, filtering the spatial frequency includes removing from the second optical image a plurality of spatial frequencies greater that the spatial frequency associated with the plurality of fibers such that the second optical image includes the bandwidth of frequencies associated with the endoscope.

In another embodiment, a method includes producing an optical image of at least a portion of a body lumen using a fiberscope. The optical image is transmitted to a video camera that is coupled to the fiberscope. A honeycomb pattern associated with a fiber bundle of the fiberscope is removed from the optical image. The method can further include displaying the image to a video monitor after removing the honeycomb pattern. In some embodiments, removing the honeycomb pattern can be done substantially in real time. In some embodiments, removing the honeycomb pattern can include an image-filtering process using a spatial frequency domain process. In some embodiments, removing the honeycomb pattern can include an image-filtering process using a space domain process. In some embodiments, the method can further include releasably coupling a calibration cap to a distal end portion of the fiberscope prior to producing the optical image, and taking an image of an interior surface of the calibration cap with the fiberscope.

In another embodiment, a processor-readable medium storing code representing instructions to cause a processor to perform a process includes code to receive a signal associated with a first optical image from a fiberscope having a plurality of imaging fibers. The code further identifies a pixel position associated with each fiber from the plurality of fibers, receive a signal associated with a second optical image from the fiberscope, and filter the pixel position associated with each fiber from the plurality of fibers from the second optical image. In some embodiments, the processor-readable medium can further include code to store the pixel positions associated with each fiber from the plurality of fibers within a memory after execution of the code to identify a pixel position. In some embodiments, the code to filter the pixel position can include code to measure an intensity of a central pixel associated with each fiber from the plurality of fibers and code to set an intensity of remaining pixels associated with each fiber from the plurality of fibers to a level of the intensity of the center pixel associated with that fiber. In some embodiments, the code to filter can be executed such that the pixel position associated with each fiber is filtered substantially in real time. In some embodiments, the processor-readable medium can further include code to display the second optical image on a video monitor after the execution of the code to filter. In some embodiments, the processor-readable medium can further include code to identify a mark coupled to at least one fiber from the plurality of fibers within the first image, and record a location of the mark in the memory.

In another embodiment, a processor-readable medium storing code representing instructions to cause a processor to perform a process includes code to receive a first plurality of signals associated with an optical image from an endoscope having a plurality of imaging fibers and perform a Fourier transform on the optical image based on the first plurality of signals to produce a second plurality of signals associated with a transformed image. The processor-readable medium also includes code to filter the transformed image based on the second plurality of signals and a selected stopband frequency to produce a third plurality of signals associated with a filtered image such that a frequency associated with an artifact in the optical image is suppressed. The frequency associated with the artifact is greater than the stopband frequency, and the artifact is associated with an imaging fiber from the plurality of imaging fibers. The processor-readable medium further includes code to normalize the filtered image based on the third plurality of signals. In some embodiments, the processor-readable medium can further include code to identify a location of a plurality of peaks within the filtered image based on a brightness of the peaks prior to execution of the code to filter, and code to identify the stopband frequency based at least in part on the identified peaks. In some embodiments, the stopband frequency is symmetric about a zero-frequency axis in the transformed image. In some embodiments, the stopband frequency forms an elliptical pattern in the transformed image. In some embodiments, the execution of the code to normalize the filtered image includes code to process a feedback loop to adjust the normalization coefficient based on a brightness of an output of the filtered image.

### CONCLUSION

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalents. Various changes in form and details of the embodiments can be made.

For example, the endoscope systems described herein can include various combinations and/or sub-combinations of the components and/or features of the different embodiments described. The endoscopes described herein can be configured to image various areas within a body. For example, an endoscope can be configured to image any body lumen or cavity, tissue or organ. The processor described herein that can be configured to remove or reduce a honeycomb pattern and/or dark spots within an image can be used with other fiberscopes not specifically descried herein. In addition, the filtering processes described herein can be incorporated into a processor used in a fiberscope imaging system, or can be provided as a separate unit (e.g., separate from an imaging processor) that can be coupled to and/or otherwise placed in communication with a processor.

An endoscope according to the invention can have a variety of different shapes and sizes, and include a different quantity of lumens, and various different features and capabilities. For example, a fiber bundle included within a fiberscope as described herein can include a variety of different quantities of fibers and the fibers can be different shapes and sizes. In some embodiments, the fibers included within a fiber bundle can each have substantially equal diameters. In some embodiments, the fibers within a fiber bundle can have different diameters from each other. Thus, the image-correction processes described herein are not dependent on the size and quantity of the fibers.

What is claimed is:

1. A method, comprising:
receiving a first optical image from an endoscope having a plurality of imaging fibers;
identifying a spatial frequency associated with the plurality of imaging fibers;
receiving a second optical image from the endoscope; and
filtering the spatial frequency from the second optical image.

2. The method of claim 1, further comprising:
storing the spatial frequency associated with the plurality of imaging fibers within a memory.

3. The method of claim 1, wherein the identifying includes performing a Fourier transform to an image having a honeycomb pattern associated with the plurality of fibers.

4. The method of claim 1, wherein the filtering includes filtering the spatial frequency substantially in real time.

5. The method of claim 1, further comprising:
displaying the second optical image on a video monitor after the filtering.

6. The method of claim 1, further comprising:
identifying a mark coupled to at least one fiber from the plurality of fibers within the first image; and
recording a location of the mark in the memory.

7. The method of claim 1, further comprising:
determining a bandwidth of frequencies associated with the endoscope based on the spatial frequency associated with the plurality of fibers, the determining being performed before the filtering.

8. The method of claim 1, further comprising:
determining a bandwidth of frequencies associated with the endoscope based on the spatial frequency associated with the plurality of fibers, the determining being performed before the filtering,
the filtering includes removing from the second optical image a plurality of spatial frequencies greater that the spatial frequency associated with the plurality of fibers such that the second optical image includes the bandwidth of frequencies associated with the endoscope.

9. A method, comprising:
producing an optical image of at least a portion of a body lumen using a fiberscope;
transmitting the optical image to a video camera coupled to the fiberscope; and
removing a honeycomb pattern associated with a fiber bundle of the fiberscope from the optical image.

10. The method of claim 9, further comprising:
after the removing, displaying the image to a video monitor.

11. The method of claim 9, wherein the removing is done substantially in real time.

12. The method of claim 9, wherein the removing includes an image-filtering process using a spatial frequency domain process.

13. The method of claim 9, wherein the removing includes an image-filtering process using a space domain process.

14. The method of claim 9, further comprising:
prior to the producing, releasably coupling a calibration cap to a distal end portion of the fiberscope; and
taking an image of an interior surface of the calibration cap with the fiberscope.

15. A processor-readable medium storing code representing instructions to cause a processor to perform a process, the code comprising code to:
receive a signal associated with a first optical image from a fiberscope having a plurality of imaging fibers;
identify a pixel position associated with each fiber from the plurality of fibers;
receive a signal associated with a second optical image from the fiberscope; and
filter the pixel position associated with each fiber from the plurality of fibers from the second optical image.

16. The processor-readable medium of claim 15, further comprising code to:
store the pixel positions associated with each fiber from the plurality of fibers within a memory, after execution of the code to identify.

17. The processor-readable medium of claim 15, wherein the filtering includes code to:
measure an intensity of a central pixel associated with each fiber from the plurality of fibers; and
set an intensity of remaining pixels associated with each fiber from the plurality of fibers to a level of the intensity of the center pixel associated with that fiber.

18. The processor-readable medium of claim 15, wherein the code to filter is executed such that the pixel position associated with each fiber is filtered substantially in real time.

19. The processor-readable medium of claim 15, further comprising code to:
display the second optical image on a video monitor after the execution of the code to filter.

20. The processor-readable medium of claim 15, further comprising code to:
identify a mark coupled to at least one fiber from the plurality of fibers within the first image; and
record a location of the mark in the memory.

21. A processor-readable medium storing code representing instructions to cause a processor to perform a process, the code comprising code to:
receive a first plurality of signals associated with an optical image from an endoscope having a plurality of imaging fibers;
perform a Fourier transform on the optical image based on the first plurality of signals to produce a second plurality of signals associated with a transformed image;
filter the transformed image based on the second plurality of signals and a selected stopband frequency to produce a third plurality of signals associated with a filtered image such that a frequency associated with an artifact in the optical image is suppressed, the frequency associated with the artifact being greater than the stopband frequency, the artifact being associated with an imaging fiber from the plurality of imaging fibers; and
normalize the filtered image based on the third plurality of signals.

22. The processor-readable medium of claim 21, further comprising code to:
prior to execution of the code to filter, identify a location of a plurality of peaks within the filtered image based on a brightness of the peaks; and
identify the stopband frequency based at least in part on the identified peaks.

23. The processor-readable medium of claim 21, wherein the stopband frequency is symmetric about a zero-frequency axis in the transformed image.

24. The processor-readable medium of claim 21, wherein the stopband frequency forms an elliptical pattern in the transformed image.

25. The processor-readable medium of claim 21, wherein the execution of the code to normalize the filtered image includes code to process a feedback loop to adjust the normalization coefficient based on a brightness of an output of the filtered image.
